(19) United States
(12) Patent Application Publication
(10) Pub. No.: US 2023/0086342 A1
(43) Pub. Date: Mar. 23, 2023

(54) USE OF SPECIFIC OPEN-CHAIN ETHER ISOCYANATES

(71) Applicant: Covestro Deutschland AG, Leverkusen (DE)

(72) Inventors: Frank Richter, Leverkusen (DE); Hooman Ghazi Zahedi, Köln (DE); Till Laurin Jessewitsch, Wuppertal (DE); Tim Loddenkemper, Dormagen (DE); Serguei Kostromine, Swisttal-Buschhoven (DE)

(21) Appl. No.: 17/802,187

(22) PCT Filed: Mar. 9, 2021
(86) PCT No.: PCT/EP2021/055897

§ 371 Date: Aug. 25, 2022

(30) Foreign Application Priority Data
Mar. 12, 2020 (EP) 20162843.5

(51) Int. Cl. C08G 18/71; C09D 175/04; C08G 18/77; C08G 18/79; C08G 18/02; C08G 18/28; C08G 18/78

(52) U.S. Cl. CPC C08G 18/711; C09D 175/04; C08G 18/771; C08G 18/792; C08G 18/022; C08G 18/282; C08G 18/7825; C08G 18/7831; C08G 18/797; C08G 18/798; C08G 18/025; C08G 18/027

(57) ABSTRACT

The invention relates to the use of at least one open-chain, optionally branched, ether isocyanate having an NCO functionality≥1, wherein 2 or 3 carbon atoms are present between at least one NCO group and at least one ether-oxygen atom, optionally in the presence of other reactants such as alcohols, amines, water, CO₂, or of other reactants having an NCO functionality≥1, optionally in the presence of at least one catalyst, to increase the reaction speed and/or to reduce the optionally required catalyst amount during isocyanate modification. The invention further relates to a process for modifying isocyanates, to the modified isocyanates as such and to a two-component system or one-component system and to the moldings, coatings and composite parts obtainable therefrom.

The invention relates to the use of specific, open-chain isocyanates containing ether groups, also referred to as “ether isocyanates” in the rest of the text. Furthermore, the invention also relates to a process for modifying isocyanates, to the modified isocyanates themselves, but also to a one-component system and a two-component system comprising the specific ether isocyanates, as well as to the shaped bodies, coatings and composite parts that can be obtained therefrom.

The oligomerization or polymerization of isocyanates, especially to form higher molecular weight oligomer mixtures having urethane (“prepolymer”), allophanate, urea, biuret, oxadiazinetrione, carbodiimide, uretdione (“dimer”), isocyanurate (“trimer”) and/or iminooxadiazinedione structures (“asymmetric trimer”) in the molecular skeleton, has long been known. As can be seen above, the oligomerization and polymerization of isocyanates are based in principle on the same chemical reactions. The reaction of a relatively small number of isocyanates with one another is referred to as oligomerization. The reaction of a relatively large number of isocyanates is referred to as polymerization. In the context of the present invention, the oligomerization or polymerization of isocyanates described above is referred to collectively as isocyanate modification or modification of isocyanates. All products resulting from such processes are referred to collectively in the present patent document as polyisocyanates, PICs for short. If the PICs contain free NCO groups, which optionally may also have been temporarily deactivated with blocking agents, they are exceptionally high-quality starting materials for the preparation of a multiplicity of polyurethane plastics and coating compositions.

A series of industrial processes for isocyanate modification have become established, in which the isocyanate to be modified, usually a diisocyanate, is generally reacted with suitable coreactants; these are alcohols or thiols in the case of PICs of the (thio)urethane (“prepolymer”) or (thio)allophanate type, amines or else water in the case of PICs of the urea or biuret type, CO₂ in the case of PICs of the oxadiazinetrione type, or else isocyanate groups themselves, from which in particular the so-called “trimers” (PICs of the isocyanurate/iminooxadiazinedione type), the so-called “dimers” (PICs of the uretdione type) and lastly the carbodiimides/uretonimines result. Carbodiimide formation releases 1 mol of CO₂ per 2 mol of NCO. Uretonimine formation usually occurs spontaneously in the presence of excess isocyanate groups at low temperature and is thermally reversible.

The predominant part of the reactions performed for PIC formation proceeds through addition of catalysts usually with partial conversion of the isocyanate groups involved. The intended reaction is terminated when the desired degree of conversion U_{NCO} of the isocyanate or isocyanate mixture to be modified is reached, or is determined by selection of the amount of alcohol/polyol or thiol/polythiol to be reacted.

In the abovementioned reactions of the isocyanate groups with one another, the catalyst usually used is rendered ineffective (deactivated) or separated off by means of suitable measures before the complete conversion of all isocyanate groups present in the starting mixture, and the PIC obtained is then usually separated from the unconverted monomers. A summary of these processes from the prior art can be found in H. J. Laas et al., J. Prakt. Chem. 1994, 336, 185 ff.

Aliphatic isocyanates exhibit a significantly lower reaction rate compared to aromatic isocyanates both in reactions with other coreactants (compounds containing OH/SH groups) and with one another. This means that the predominant part of these reactions has to be catalyzed or, where this is not possible or is undesirable, carried out at a higher temperature, this frequently being disadvantageous.

The object of the invention was therefore to produce polyisocyanates from aliphatic isocyanates, these disadvantages occurring to a lesser extent, if at all, in the case of said isocyanates, which are “intrinsically” catalyzed.

As has now surprisingly been found, this is the case with specific open-chain, optionally branched, isocyanates containing ether groups, also referred to as “ether isocyanates” in the rest of the text.

Ether isocyanates have long been generally known. Gas-phase phosgenation of commercially available amines has in particular made the industrial route to said ether isocyanates significantly easier, as described in EP 0 764 633 A2 and the prior art cited therein. By contrast, polyisocyanates produced from the ether isocyanates are not disclosed.

A subject of the invention is the use of at least one open-chain, optionally branched, ether isocyanate having an NCO functionality≥1, in which 2 or 3 carbon atoms are located between at least one NCO group and at least one ether oxygen atom, optionally in the presence of further coreactants such as alcohols, amines, water, CO₂, or else further isocyanates having an NCO functionality≥1, optionally in the presence of at least one catalyst, for increasing the reaction rate and/or reducing the optionally required amount of catalyst in isocyanate modification.

The references to “comprising”, “containing”, etc. preferably denote “substantially consisting of” and very particularly preferably denote “consisting of”.

In a first preferred embodiment, the use is characterized in that the at least one open-chain, optionally branched, ether isocyanate has an NCO functionality of 2 and 2 or 3 carbon atoms are located at least between one of the two NCO groups and the at least one ether oxygen atom.

Coreactants used for providing the PICs, in addition to the open-chain, optionally branched, ether isocyanates themselves, may be the usually difunctional and higher-functionality coreactants having Zerevitinoff-active hydrogen that are customary in polyurethane chemistry, for example water, alcohols, thiols and amines. These compounds preferably have an average OH, NH or SH functionality of at least 1.5. These may, for example, be low molecular weight diols (e.g. ethane-1,2-diol, propane-1,3- or −1,2-diol, butane-1,4-diol), triols (e.g. glycerol, trimethylolpropane) and tetraols (e.g. pentaerythritol), short-chain polyamines, but also polyaspartic esters, polythiols and/or polyhydroxy compounds such as polyether polyols, polyester polyols, polyurethane polyols, polysiloxane polyols, polycarbonate polyols, polyether polyamines, polybutadiene polyols, polyacrylate polyols and/or polymethacrylate polyols, and the copolymers thereof.

Therefore, according to a further preferred embodiment, in the use according to the invention or the process according to the invention at least one further coreactant selected from the group consisting of alcohols, amines, water, CO₂ and further isocyanates having an NCO functionality≥1 that preferably do not contain an ether group is present.

As catalysts to be optionally used in addition for the NCO—NCO reactions without the involvement of further coreactants, use may in principle be made of all species that are known to be catalytically active with respect to isocyanates. These include, in addition to compounds of ionic structure for example with “onium” cations (ammonium, phosphonium, etc.) and nucleophilic anions such as hydroxide, alkanoate, carboxylate, heterocycles having at least one negatively charged nitrogen atom in the ring, especially azolate, imidazolate, triazolate, tetrazolate, fluoride, hydrogendifluoride, higher polyfluorides or mixtures of these (adducts of more than one equivalent of HF onto compounds containing fluoride ions), it being possible for the fluorides, hydrogendifluorides and higher polyfluorides to lead under suitable reaction conditions to products having a higher iminooxadiazinedione group content, also neutral bases such as tertiary amines or phosphanes (phosphines). Especially in the latter case structural variation makes it possible to cover a wide selectivity range; from high uretdione selectivity through to high “trimer” selectivity, the latter typically resulting in mixtures of isocyanurates and iminooxadiazinediones.

The optional catalysts may be used individually or in any desired mixtures with one another. For instance, the solutions of quaternary ammonium hydroxides in various alcohols, depending on the pKₐ value of the base and of the alcohol used, are present partially or completely as ammonium salts with alkoxide anion. This equilibrium can be shifted wholly to the side of complete alkoxide formation by removing the water of reaction resulting from this reaction. Suitable methods for water removal here are all methods known from the literature for this purpose, in particular (azeotropic) distillation, this optionally being with the aid of a suitable entrainer if the alcohol used as solvent is not suitable as such.

With the use according to the invention or the process according to the invention, a wide range of high-quality, reactive polyisocyanates, which are therefore very valuable for the polyurethane sector, is very generally obtainable in a simple manner. Depending on the starting (di)isocyanate used, coreactants and the reaction conditions, the process results in polyisocyanates of the so-called urethane (“prepolymer”), allophanate, urea, biuret, oxadiazinetrione, carbodiimide, uretdione (“dimer”), isocyanurate (“trimer”) and/or iminooxadiazinedione (“asymmetric trimer”) structure type. Mixtures that contain a plurality of the abovementioned structure types are usually formed. The use where modified isocyanates having a urethane, urea, biuret, dimer, isocyanurate, iminooxadiazinedione and/or carbodiimide structure are produced from the at least one open-chain, optionally branched, ether isocyanate is therefore a further preferred embodiment of the present invention.

In the use according to the invention or the process according to the invention, provision may further be made for the oligomerization to be conducted in the presence of a solvent and/or additive.

In the use according to the invention or the process according to the invention, use may in principle be made of all open-chain, optionally branched, ether isocyanates of the structure specified at the outset, that is to say mono-, di- or polyisocyanates in which 2 or 3 carbon atoms are located between at least one NCO group and at least one ether oxygen atom, individually or in any desired mixtures with one another and with further isocyanates from the prior art.

Examples of ether isocyanates to be used according to the invention include all regio- and (optionally, where possible) stereoisomers of the following open-chain, optionally branched, isocyanates, in which 2 or 3 carbon atoms are located between at least one NCO group and at least one ether oxygen atom:

methoxyethyl isocyanate, methoxypropyl isocyanate, methoxybutyl isocyanate, methoxypentyl isocyanate, methoxyhexyl isocyanate, methoxyheptyl isocyanate, methoxyoctyl isocyanate, methoxydecyl isocyanate, ethoxyethyl isocyanate, ethoxypropyl isocyanate, ethoxybutyl isocyanate, ethoxypentyl isocyanate, ethoxyhexyl isocyanate, ethoxyheptyl isocyanate, ethoxyoctyl isocyanate, ethoxydecyl isocyanate, propoxyethyl isocyanate, propoxypropyl isocyanate, propoxybutyl isocyanate, propoxypentyl isocyanate, propoxyhexyl isocyanate, propoxyheptyl isocyanate, propoxyoctyl isocyanate, propoxydecyl isocyanate, butoxyethyl isocyanate, butoxypropyl isocyanate, butoxybutyl isocyanate, butoxypentyl isocyanate, butoxyhexyl isocyanate, butoxyheptyl isocyanate, butoxyoctyl isocyanate, butoxydecyl isocyanate, pentoxyethyl isocyanate, pentoxypropyl isocyanate, pentoxybutyl isocyanate, pentoxypentyl isocyanate, pentoxyhexyl isocyanate, pentoxyheptyl isocyanate, pentoxyoctyl isocyanate, pentoxydecyl isocyanate, hexoxyethyl isocyanate, hexoxypropyl isocyanate, hexoxybutyl isocyanate, hexoxypentyl isocyanate, hexoxyhexyl isocyanate, hexoxyheptyl isocyanate, hexoxyoctyl isocyanate, hexoxydecyl isocyanate, heptoxyethyl isocyanate, heptoxypropyl isocyanate, heptoxybutyl isocyanate, heptoxypentyl isocyanate, heptoxyhexyl isocyanate, heptoxyheptyl isocyanate, heptoxyoctyl isocyanate, heptoxydecyl isocyanate, bis(isocyanatoethyl) ether; bis(isocyanatopropyl) ether; bis(isocyanatobutyl) ether, bis(isocyanatopentyl) ether, bis(isocyanatohexyl) ether, bis(isocyanatoheptyl) ether, bis(isocyanatooctyl) ether, bis(isocyanatodecyl) ether.

The abovementioned isocyanates are obtainable for example from the corresponding:
alkyl aminoalkyl ethers of the general formulae H₂N—C(R¹,R²)—C(R³,R⁴)—O—R⁷ and H₂N—C(R¹,R²)—C(R³,R⁴)—C(R⁵,R⁶)—O—R⁷, where R¹ to R⁶, independently of one another, for H or open-chain or branched C₁ to C₂₀ substituents (aliphatic, cycloaliphatic, araliphatic, aromatic) and R⁷, independently of one another, for open-chain or branched C₁ to C₂₀ substituents (aliphatic, cycloaliphatic, araliphatic, aromatic), in particular 2-aminoethyl methyl ether, 2-aminoethyl ethyl ether, 2-aminoethyl propyl ether, 2-aminopropyl methyl ether, 2-aminopropyl ethyl ether, 2-aminopropyl propyl ether, 3-aminopropyl methyl ether, 3-aminopropyl ethyl ether, 3-aminopropyl propyl ether,
diaminooxoalkanes of the general formula H₂N—C(R¹,R²)—C(R³,R⁴)—O—C(R⁵,R⁶)—C(R⁸,R⁹)—NH₂ and H₂N—C(R¹,R²)—C(R³,R⁴)—C(R⁵,R⁶)—O—C(R⁸,R⁹)—C(R¹⁰,R¹¹)—C(R¹²,R¹³)—NH₂, where R¹ to R¹³ have the meaning defined further above for R¹ to R⁶, in particular bis(2-aminoethyl) ether, bis(2-aminopropyl) ether, bis(3-aminopropyl) ether, 2-aminoethyl 3-aminopropyl ether and technical mixtures of the abovementioned diamines,
diamino(poly)oxoalkanes of the general formula H₂N-[C(R¹,R²)—C(R³,R⁴)—O]ₙ—C(R⁵,R⁶)—C(R⁸,R⁹)—NH₂ and H₂N—[C(R¹,R²)—C(R³,R⁴)—C(R⁵,R⁶)—O]—C(R⁸,R⁹)—C(R¹⁰,R¹¹)—C(R¹²,R¹³)—NH₂, where R¹ to R¹³ have the meaning defined further above for R¹ to R⁶ and n may be integers between 1 and 6, in particular 1,8-diamino-1,5,8-trimethyl-3,6-dioxaoctane, 1,11-diamino-1,5,8,11-tetramethylundecane and all isomers of the two latter compounds having vicinal O—N linkage in pure form or as a mixture (for example as technical Jeffamine© D-230), diamino-3,6-dioxaoctane (for example as technical Jeffamine© EDR-148), 1,10-diamino-4,7-dioxadecane, 1,12-diamino-4,9-dioxadodecane, 1,14-diamino-3,10-dioxatetradecane, 1,13-diamino-4,7,10-trioxatridecane and others,
triamino(poly)oxoalkanes such as 1,7-diamino-2,6-dioxa-4-aminomethoxyheptane, 1-amino-2-oxa-3,3-bis(aminomethoxy)hexane, 1,9-diamino-3,7-dioxa-5-(1-amino-2-ethoxy)nonane, 1-amino-3-oxa-4,4-bis(1-amino-2-ethoxy)heptane, 1,11-diamino-4,8-dioxa-6-(1-amino-5-oxabutyl)undecane, 1-amino-4-oxa-5,5-bis(1-amino-5-oxabutyl)octane and mixtures of the abovementioned mono-, di- and triamines.

The amines to be used here as starting material may for example be obtained

(1.) by alkoxylation of water or other, optionally poly-, OH-functional compounds such as alcohols, phenols and/or carboxylic acids, and subsequent amination, for example as described in French patent specification 1 361 810,

(2.) by polymerization of tetrahydrofuran and, optionally after further reaction with alkylene oxide, subsequent treatment as described under (1),

(3.) by cyanoethylation of water and subsequent hydrogenation to form bis(3-aminopropyl) ether, described inter alia in German Reich Patent 731 708, or by cyanoethylation of other, optionally poly-, OH-functional compounds, in particular of diols and triols, and subsequent hydrogenation.

Further isocyanates from the prior art that can be used in the use according to the invention or the process according to the invention in a blend with the open-chain, optionally branched, ether isocyanates include the following: pentamethylene diisocyanate (PDI), hexamethylene diisocyanate (HDI), 2-methylpentane 1,5-diisocyanate, 2,4,4-trimethylhexane 1,6-diisocyanate, 2,2,4-trimethylhexane 1,6-diisocyanate, 4-isocyanatomethyloctane 1,8-diisocyanate, 3(4)-isocyanatomethyl-1-methylcyclohexyl isocyanate (IMCI), isophorone diisocyanate (IPDI), 1,3- and 1,4-bis(isocyanatomethyl)benzene (XDI), 1,3- and 1,4-bis(isocyanatomethyl)cyclohexane (H₆XDI), tolylene 2,4- and 2,6-diisocyanate (TDI), bis(4-isocyanatophenyl)methane (4,4′MDI), 4-isocyanatophenyl-2-isocyanatophenylmethane (2,4′MDI) and polycyclic products obtainable by formaldehyde-aniline polycondensation and subsequent conversion of the resulting (poly)amines to the corresponding (poly)isocyanates (polymer MDI).

Particular preference is given to pentamethylene diisocyanate (PDI), hexamethylene diisocyanate (HDI), 2-methylpentane 1,5-diisocyanate, 2,4,4-trimethylhexane 1,6-diisocyanate, 2,2,4-trimethylhexane 1,6-diisocyanate, 4-isocyanatomethyloctane 1,8-diisocyanate, 3(4)-isocyanatomethyl-1-methylcyclohexyl isocyanate (IMCI), isophorone diisocyanate (IPDI), 1,3- and 1,4-bis(isocyanatomethyl)benzene (XDI) and 1,3- and 1,4-bis(isocyanatomethyl)cyclohexane (H₆XDI).

The amount of the latter isocyanates that do not contain ether groups is guided by the specific application and, if they are used at all, may vary within wide limits, between 1% and 99% by weight, based on the total amount of compounds that have NCO groups. If it is desired to benefit more from the reaction-accelerating effect of the open-chain, optionally branched, ether isocyanates used according to the invention, greater proportions of these ether isocyanates are used (50-99% by weight).

In a further preferred embodiment, between 1% and 99% by weight, based on the total amount of compounds that have NCO groups, of the at least one open-chain, optionally branched, ether isocyanate is used, the balance to 100% consisting of one or more further isocyanates having an NCO functionality≥1. The amount is particularly preferably between 50% and 90% by weight, based on the total amount of compounds that have NCO groups, of the at least one open-chain, optionally branched, ether isocyanate for use, the balance to 100% consisting of one or more further isocyanates having an NCO functionality≥1.

It is irrelevant by which processes the abovementioned isocyanates are generated, i.e. with or without use of phosgene. Preferred in the industrial production of the open-chain, optionally branched, ether isocyanates is the gas-phase phosgenation as described in EP 0 764 633 A2.

The amount of the catalyst optionally to be used in the use according to the invention or the process according to the invention is guided primarily by the organic isocyanate used and the target reaction rate and is preferably between >0.001 and ≤4 mol %, more preferably between >0.002 and ≤1.5 mol %, based on the sum total of the amounts of substance of the isocyanate used and of the catalyst, and is less according to the invention than in the case of the exclusive use of aliphatic isocyanates that do not contain an ether group in the 2 or 3 position with respect to the NCO group.

In the use according to the invention or the process according to the invention, the optional catalyst may be used undiluted or dissolved in solvents. Useful solvents here are all compounds which do not react with the catalyst and are capable of dissolving it to a sufficient degree, for example optionally halogenated aliphatic or aromatic hydrocarbons, alcohols, ketones, esters and ethers. Preference is given to using alcohols.

The use according to the invention or the process according to the invention can be conducted in the temperature range between 0° C. and +250° C., preferably 20° C. to 200° C., particularly preferably 40° C. to 150° C., and can be interrupted at any desired degrees of conversion, preferably after 5% to 80%, particularly preferably 10% to 60%, of the isocyanate (mixture) used has been converted.

Catalyst deactivation can be accomplished in principle by employing a whole series of previously described methods from the prior art, such as the addition of (sub- or super-)stoichiometric amounts of acids or acid derivatives (for example benzoyl chloride, acidic esters of phosphorus- or sulfur-containing acids, these acids themselves, etc., but not HF), adsorptive binding of the catalyst and subsequent removal by filtration, and other methods known to those skilled in the art.

In a further preferred embodiment, unconverted organic isocyanate is removed after deactivation of the catalyst system by any desired process from the prior art, for example by (thin film) distillation or extraction, and preferably subsequently reused.

According to a particular, continuously operating embodiment, the isocyanate modification can be undertaken continuously, for example in a tubular reactor.

In addition to the use according to the invention, a process for modifying isocyanates, comprising the reaction of at least one open-chain, optionally branched, ether isocyanate having an NCO functionality≥1, in which 2 or 3 carbon atoms are located between at least one NCO group and at least one ether oxygen atom, optionally in the presence of further coreactants such as alcohols, amines, water, CO₂, or else further isocyanates having an NCO functionality≥1, is likewise a subject of the present invention. For the process according to the invention, the further embodiments identified in the claims and in the description are just as valid and can be combined arbitrarily, provided that the context does not clearly indicate that the opposite is the case.

The products or product mixtures obtainable by the use according to the invention or the process according to the invention are consequently versatile starting materials for the production of, optionally foamed, plastic(s) and of paints, coating compositions, adhesives and additives.

A further subject of the invention is therefore a modified isocyanate obtainable or produced by the process according to the invention.

The process products can be used as such or in conjunction with other isocyanate derivatives from the prior art, such as polyisocyanates containing uretdione, biuret, allophanate, isocyanurate and/or urethane groups, the free NCO groups of which optionally have been deactivated with blocking agents.

A further subject of the present invention is therefore a one-component system comprising at least one modified isocyanate based on an open-chain, optionally branched, ether isocyanate having an NCO functionality≥1, in which 2 or 3 carbon atoms are located between at least one NCO group and at least one ether oxygen atom, the free NCO groups of which have been deactivated with one or more blocking agents. Suitable blocking agents for deactivating isocyanate groups are known to those skilled in the art.

Likewise subjects of the present invention are a two-component system containing a component A), comprising at least one modified isocyanate based on an open-chain, optionally branched, ether isocyanate having an NCO functionality≥1, in which 2 or 3 carbon atoms are located between at least one NCO group and at least one ether oxygen atom, and a component B), comprising at least one NCO-reactive compound, and a shaped body or a coating obtainable or produced by curing a two-component system according to the invention, optionally under the action of heat and/or in the presence of a catalyst, but also the substrates coated with at least one two-component system according to the invention that has been cured optionally under the action of heat. Since the modified isocyanates according to the invention can be found in the cured coatings or shaped bodies, a composite component comprising a material that is joined at least to a shaped body according to the invention or a coating according to the invention at least in part is likewise a subject of the invention.

In the case of the further subjects of this invention, the embodiments identified above for the use according to the invention and/or the process according to the invention are likewise valid and the preferences apply accordingly, provided that the context does not directly indicate that the opposite is the case.

In the present case, the term “modified isocyanate” has the meaning defined at the outset and preferably represents a polyisocyanate having a statistical average of at least 1.5 NCO groups.

NCO-reactive compounds of component B) used may be all compounds known to those skilled in the art—including in any desired mixtures with one another—that have an average OH, NH or SH functionality of at least 1.5. These may, for example, be low molecular weight diols (e.g. ethane-1,2-diol, propane-1,3- or −1,2-diol, butane-1,4-diol), triols (e.g. glycerol, trimethylolpropane) and tetraols (e.g. pentaerythritol), short-chain polyamines, but also polyaspartic esters, polythiols and/or polyhydroxy compounds such as polyether polyols, polyester polyols, polyurethane polyols, polysiloxane polyols, polycarbonate polyols, polyether polyamines, polybutadiene polyols, polyacrylate polyols and/or polymethacrylate polyols, and the copolymers thereof, called polyacrylate polyols hereinafter.

According to a further preferred embodiment, the NCO-reactive compound is a polyhydroxy compound, preferably a polyether polyol, polyester polyol, polycarbonate polyol or polyacrylate polyol.

The two-component system according to the invention optionally contains auxiliaries and additives, which may for example be the following that are known to those skilled in the art: cobinders, desiccants, fillers, cosolvents, color or effect pigments, thickeners, matting agents, light stabilizers, coatings additives such as dispersants, thickeners, defoamers and other auxiliaries such as adhesives, fungicides, bactericides, stabilizers or inhibitors and catalysts or emulsifiers.

The comparative examples and examples which follow are intended to further illustrate the invention but without limiting it.

### EXAMPLES

All percentages, unless noted otherwise, are to be understood to mean percent by weight.

Mol % data were determined by ¹H NMR spectroscopy and always relate, unless noted otherwise, to the sum total of the NCO conversion products. The measurements were conducted on the Bruker DPX 400 or DRX 700 instruments on approx. 5% (H NMR) or approx. 50% (¹³C NMR) samples in dry C₆D₆, unless noted otherwise, at 400 or 700 MHz (H NMR) or 100 or 176 MHz (¹³C NMR).

The reference employed for the ppm scale was tetramethylsilane in the solvent with ¹H NMR chemical shift 0 ppm. Alternatively, C₆D5H present in the NMR solvent was used as reference signal (7.15 ppm, ¹H-NMR), or the solvent signal itself (average signal of the 1:1:1 triplet at 128.0 ppm in the ¹³C NMR. ¹⁵N-NMR chemical shifts were indirectly determined by means of ¹H-¹⁵N-HMBC measurements, where external reference was made to (liquid) ammonia (0 ppm).

Dynamic viscosities were determined at 23° C. using the MCR 501 rheometer (from Anton Paar) in accordance with DIN EN ISO 3219:1994-10. Measurement at different shear rates ensured that Newtonian flow behavior can be assumed. Details regarding the shear rate can therefore be omitted.

The NCO content was determined by titration in accordance with DIN EN ISO 10283:2007-11.

The residual monomer content was determined by gas chromatography in accordance with DIN EN ISO 10283:2007-11 with internal standard.

GC-MS was performed using the Agilent GC6890, equipped with an MN 725825.30 Optima-5 MS Accent capillary column (30 m, 0.25 mm internal diameter, 0.5 μm film layer thickness) and a 5973 mass spectrometer as detector with helium as transport gas (flow rate of 2 ml/min). The column temperature was initially 60° C. (2 min) and was then increased gradually by 8K/min to 360° C. The GC-MS detection used electron impact ionization with 70 eV ionization energy. The injector temperature chosen was 250° C.

Size exclusion chromatography (SEC) was performed in accordance with DIN 55672-1:2016-03 with tetrahydrofuran as eluent.

X-ray crystal structure analysis took place on an Oxford Diffraction Xcalibur equipped with a CCD area detector (Ruby model), a Cu_{K,α} source and Osmic mirrors as monochromator at 106-107 K. The program CrysAlis Version 1.171.38.43 (Rigaku 2015) was used for data acquisition and reduction. SHELXTL Version 6.14 (Bruker AXS, 2003) was used for structural resolution.

The Hazen color number was measured by spectrophotometry in accordance with DIN EN ISO 6271-2:2005-03 using a LICO 400 spectrophotometer from Lange, Germany.

All reactions were conducted under a nitrogen atmosphere in glass apparatuses dried beforehand under reduced pressure at 150-200° C.

The diisocyanates used are products from Covestro. All other commercially available chemicals were obtained from Aldrich, D-82018 Taufkirchen.

Production of Starting Materials for Experiments According to the Invention and Comparative Experiments:

A) Production of 4-methoxy-1-butanamine

2(4-Methoxybutyl)-1H-isoindole-1.3(211)dione

1.4 liters of DMF, 352 g of phthalimide and 780 g of cesium carbonate were initially charged into a 4 liter four-necked flask and 400 g of 1-bromo-4-methoxybutane were added dropwise with stirring at 70° C. The reaction mixture was kept at this temperature for four hours, cooled and then introduced into ice water with stirring. The product precipitates in crystalline form, is filtered off, rinsed on the filter with water and subsequently dried under reduced pressure. 519.1 g (93% of theory)

### 4-Methoxy-1 butanamine

520 g of 2-4-methoxybutyl)-1˜isoindole-1,3(2hydrazine and 167 g of hydrazine monohydrate in methanol were initially charged into a 4 liter four-necked flask and stirred under reflux for two hours.

The solution was cooled and 3% aqueous HCl solution was added with stirring.

The precipitating solids were filtered off and disposed of. The mother liquor was made strongly alkaline with 200 ml of 50% NaOH solution and the product was extracted with diethyl ether. After drying with magnesium sulfate, concentration and distillation were performed. 295 g (79% of theory)

B) Production of the ether isocyanates and comparative compounds having an NCO function

In each case a mixture consisting of 2 mol of isophorone diisocyanate and 2 mol of Desmodur® 2460 M (mixture of 4,4′- and 2,4′-diphenylmethane diisocyanate) were initially charged into a 1 liter four-necked flask with effective magnetic stirrer, dropping funnel with pressure equalization, internal temperature control, attached 40 cm-long Vigreux column and adjoining dephlegmator, and 1 mol of the monoamine to be converted to the respective isocyanate were weighed into the dropping funnel with pressure equalization. With stirring, the initially charged diisocyanate was subsequently brought to an internal temperature of 150-160° C. and the monoamine was rapidly added dropwise into the high-boiling diisocyanate mixture (exothermicity up to approx. 180° C.) and distillate that distills over was removed batchwise. Distillate was then removed by gradual reduction of the system pressure until the boiling temperature of the high-boiling diisocyanate mixture was achieved at the top.

The distillates thus obtained were subsequently fractionated in order to obtain the pure monoisocyanates 1-6 in 70-90% yields, based on the amine used.

TABLE 1
Monoisocyanates

| No. and formula | B.p. (° C.) at | p [mbar] | n_{D}²⁰ |
|---|---|---|---|
| 1 CH₃OCH₂CH₂NCO | 68 | 120 | 1.4082 |
| 2 CH₃OCH₂C(H,CH₃)NCO | 67 | 92 | 1.4090 |
| 3 CH₃OCH₂CH₂CH₂NCO | 73 | 80 | 1.4171 |
| 4 CH₃CH₂CH₂CH₂NCO | 115 | 1013 | 1.4060 |
| 5 CH₃CH₂CH₂C(H,CH₃)NCO | 71 | 153 | 1.4077 |
| 6 CH₃OCH₂CH₂CH₂CH₂NCO | 80 | 40 | 1.4242 |

The diisocyanates used in Examples 2 to 4 with ether function were produced analogously to the procedure from Example 1 of EP 0 764 633 A2.

### Examples 1a to 1i Urethanization (1a to 1e: According to the Invention, 1f to 1i: Comparative Examples)

In each case 1.5 mol of n-butanol were heated to 50° C. with magnetic stirring in a 250 ml three-necked flask with septum for the metering of the respective isocyanate used, internal temperature control and reflux condenser, and then 0.1 mol of the respective monoisocyanate or 0.05 mol of the respective diisocyanate were quickly injected. Removal of the heating bath and—especially at the beginning of 1a—any necessary cooling with an ice bath allowed the internal temperature to be kept at 50° C.

The NCO content and thus the conversion was monitored titrimetrically at regular intervals. The time (t_{1/2}) after which only 50% of the originally present NCO groups were present was used to compare the reactivity of the isocyanates used in the experiments according to the invention (1a to 1e) and the comparative experiments (1f to 1i), cf. Table 2.

TABLE 2
Urethanizations

| Example 1 | Isocyanate used | t_{1/2} [sec] |
|---|---|---|
| a | CH₃OCH₂CH₂NCO | 1740 |
| b | CH₃OCH₂C(H,CH₃)NCO | 3650 |
| c | CH₃OCH₂CH₂CH₂NCO | 2200 |
| d | OCNCH₂CH₂OCH₂CH₂NCO | 900 |
| e | OCNCH₂CH₂CH₂OCH₂CH₂CH₂NCO | 2300 |
| f | CH₃CH₂CH₂CH₂NCO | 2900 |
| g | CH₃CH₂CH₂C(H,CH₃)NCO | 10 000 |
| h | CH₃OCH₂CH₂CH₂CH₂NCO | 2900 |
| i | OCNCH₂CH₂CH₂CH₂CH₂CH₂NCO | 2500 |

As can readily be identified from the comparison of the t_{1/2} values, the structurally comparable isocyanates are always significantly more reactive in the presence of an ether oxygen atom in the 2 or 3 position than the counterparts having a CH₂ group instead of oxygen. Even though isocyanate groups bound to secondary carbon atoms are generally less reactive than those bound to primary carbon atoms, the comparison of the results from Example 1b (according to the invention) with Example 1g (comparative) shows that a considerable activation of the NCO group with respect to the urethanization reaction is also able to be recorded here. This effect is more pronounced in the case of the O—C—C—NCO-linked derivatives than in the case of those having 3 carbon atoms between the NCO group and the next oxygen atom in the chain. In the case of the latter, however, said effect is still clearly apparent, but no longer occurs when a further CH₂ unit is incorporated (Ex. 1h, comparative).

### Examples 2a and 2b Trimerization (2a: According to the Invention, 2b: Comparative Example)

In a 100 ml three-necked flask with septum for the metering of the catalyst, internal temperature control and reflux condenser, with magnetic stirring, 39 g (386 mmol) of 2-methoxyethyl isocyanate 1 (Example 2a, according to the invention) or 38.2 g (386 mmol) of n-butyl isocyanate 5 (Example 2b, comparative) were admixed at 60° C. dropwise with a 50% solution of 5-azoniaspiro[4.5]decanium hydrogendifluoride in 2-propanol.

In Example 2a according to the invention, after addition of a total of 23 mg of catalyst solution and short incubation time, a strongly exothermic reaction began which was able to be limited to a maximum of 70° C. by cooling with an ice bath. After 50 min approx. 50% of the 1 used had been converted into a mixture of isocyanurate and iminooxadiazinedione. In the further course of reaction, further monomer conversion was able to be recorded without additional catalyst addition. Crystallization began after distillative removal of the unconverted monomer 1. Recrystallization from methylene chloride/n-hexane yielded single crystals, m.p.: 45° C., which were identified by means of X-ray crystal structure analysis as N,N′,N″-tris(2-methoxyethyl) isocyanurate (isocyanurate-type trimer from 1).

In Comparative Example 2b, significantly more catalyst solution was required (28 mg), the conversion thus achievable after approx. 45 min was only 14% and then increased only very slowly without further catalyst addition. The temperature increase during the reaction was also significantly more moderate. The N,N′,N″-tris(n-butyl) isocyanurate isolated distillatively after monomer removal, b.p. 120° C./0.01 mbar, was obtained as a slightly viscous liquid that does not crystallize even after storage in a refrigerator.

These investigations prove, on the one hand, the significantly increased reactivity of the open-chain, optionally branched, ether isocyanates according to the invention, such as 1, even in NCO—NCO reactions on the one hand and, on the other hand, that the replacement of a methylene group in 5 by an oxygen atom (1) surprisingly results in products having significantly different physical properties—here the melting point.

### Examples 3a, b and c Trimerization (3a and b: According to the Invention, 3c: Comparative Example)

In a 1 liter three-necked flask with septum for the metering of the catalyst, internal temperature control and reflux condenser, with mechanical stirring, 500 g (3.2 mol) of bis(2-isocyanatoethyl) ether (Example 3a, according to the invention), 590 g (3.2 mol) of bis(3-isocyanatpropyl) ether (Example 3b, according to the invention) or 494 g (3.2 mol) of pentamethylene diisocyanate (Example 2c, comparative) were admixed at 60° C. dropwise with “isooctyl phobane” (isomer mixture, consisting of 9-(2,4,4-trimethylpentyl)-9-phosphabicyclo[3.3.1]nonane and 9-(2,4,4-trimethylpentyl)-9-phosphabicyclo[4.2.1]nonane) until a slight exothermicity and a continuous decrease in the NCO content was able to be recorded.

In Examples 2a and 2b according to the invention, after addition of a total of 846 mg and 956 mg, respectively, of catalyst (0.1 and 0.12 mol %, respectively, based on the catalyst and diisocyanate used), this effect began. By occasionally removing the external heat source, the reactions were able to be performed in a readily controllable manner at approx. 60° C. In Comparative Example 3c, 12.2 g of catalyst (1.5 mol %, based on the catalyst and diisocyanate used) were necessary for this purpose. Over the course of 4 to 5 hours, the NCO contents of the mixtures had decreased by approx. 20% in each case. After the catalyst had been deactivated by addition of elemental sulfur (1.1 equivalents based on the catalyst), stirring for a further thirty minutes at 60° C. and subsequent distillative monomer removal, the result in Examples 3a and 3b according to the invention was light-colored (<50 APHA), viscous resins; the product from Comparative Example 3c exhibited, due to the significantly higher catalyst consumption, a significantly higher color number (120 APHA). The further data can be found in Table 3.

TABLE 3
Trimerizations

| | | NCO | |
|---|---|---|---|
| | | content | Viscosity |
| Example 3 | Diisocyanate used | [%] | [mPas]* |
| a | OCNCH₂CH₂OCH₂CH₂NCO | 14.2** | 3840** |
| b | OCNCH₂CH₂CH₂OCH₂CH₂CH₂NCO | 19.5 | 1360 |
| c | OCNCH₂CH₂CH₂CH₂CH₂NCO | 23.5 | 5480 |

*at 23° C.
**80% solution in butyl acetate, the 100% resin is of extremely high viscosity

These investigations likewise prove the significantly increased reactivity of the specific open-chain, optionally branched, ether isocyanates and, on the other hand, that the replacement of a methylene group by an oxygen atom also in diisocyanate conversion products results in products having significantly different physical properties—here in particular in Example 3a the viscosity.

### Example 4: Trimerization

In a 4 liter three-necked flask with dropping funnel with pressure equalization for the metering of the catalyst, internal temperature control and reflux condenser, with mechanical stirring, 2700 g (14.7 mol) of an isomer mixture obtained in accordance with EP 0 764 633 A2, Example 1 (therein as “dipropylene glycol diisocyanate, isomer mixture”) were admixed at 60° C. dropwise with a total of 15.9 g of a 10% solution of benzyltrimethylammonium hydroxide in 2-ethyl-1,3-hexanediol such that, with moderate exothermicity, a continuous decrease in the NCO content was able to be recorded.

Over the course of approx. 6 hours, the NCO content had fallen from initially 45.4% to 36.6%. The reaction was concluded by addition of 2.1 g of di-n-butyl phosphate so as to deactivate the catalyst and, after stirring for a further thirty minutes at 60° C. and subsequent distillative monomer removal, the result was 900 g of a highly viscous (48 Pas), clear, virtually colorless polyisocyanate resin having an NCO content of 19.2%.

1: In a process for increasing the reaction rate and/or reducing the optionally required amount of catalyst in isocyanate modification, the improvement comprising including at least one open-chain, optionally branched, ether isocyanate having an NCO functionality≥1, in which 2 or 3 carbon atoms are located between at least one NCO group and at least one ether oxygen atom, optionally in the presence of further coreactants such as alcohols, amines, water, CO₂, or further isocyanates having an NCO functionality≥1, optionally in the presence of at least one catalyst.

2: The process as claimed in claim 1, characterized in that the at least one open-chain, optionally branched, ether isocyanate has an NCO functionality of 2 and 2 or 3 carbon atoms are located at least between one of the two NCO groups and the at least one ether oxygen atom.

3: The process as claimed in claim 1, characterized in that at least one further coreactant selected from the group consisting of alcohols, amines, water, CO₂ and further isocyanates having an NCO functionality≥1 that do not contain an ether group is present.

4: The process as claimed in claim 1, characterized in that between 1% and 99% by weight, based on the total amount of compounds that have NCO groups, of the at least one open-chain, optionally branched, ether isocyanate is used, the balance to 100% consisting of one or more further isocyanates having an NCO functionality≥1.

5: The process as claimed in claim 4, characterized in that the amount of the at least one open-chain, optionally branched, ether isocyanate is between 50% and 90% by weight.

6: The process as claimed in claim 1, characterized in that modified isocyanates having a urethane, urea, biuret, dimer, isocyanurate, iminooxadiazinedione and/or carbodiimide structure are produced from the at least one open-chain, optionally branched, ether isocyanate.

7: A process for modifying isocyanates, comprising the reaction of at least one open-chain, optionally branched, ether isocyanate having an NCO functionality≥1, in which 2 or 3 carbon atoms are located between at least one NCO group and at least one ether oxygen atom, optionally in the presence of further coreactants selected from the group consisting of alcohols, amines, water, CO₂, and further isocyanates having an NCO functionality≥1.

8: A modified isocyanate produced by the process as claimed in claim 7.

9: A two-component system containing a component A), comprising at least one modified isocyanate based on an open-chain, optionally branched, ether isocyanate having an NCO functionality≥1, in which 2 or 3 carbon atoms are located between at least one NCO group and at least one ether oxygen atom, and a component B), comprising at least one NCO-reactive compound.

10: The two-component system as claimed in claim 9, wherein the at least one NCO-reactive compound is a polyhydroxy compound, selected from the group consisting of a polyether polyol, a polyester polyol, a polycarbonate polyol, and a polyacrylate polyol.

11: A one-component system comprising at least one modified isocyanate based on an open-chain produced according to claim 1, optionally branched, ether isocyanate having an NCO functionality≥1, in which 2 or 3 carbon atoms are located between at least one NCO group and at least one ether oxygen atom, the free NCO groups of which have been deactivated with one or more blocking agents.

12: A shaped body or coating obtainable or produced by curing a two-component system as claimed in claim 9, optionally under the action of heat and/or in the presence of a catalyst.

13: A composite component comprising a material joined at least to a shaped body or a coating as claimed in claim 12 at least in part.
